(19) United States
(12) Patent Application Publication
(10) Pub. No.: US 2012/0044412 A1
(43) Pub. Date: Feb. 23, 2012

(54) CAMERA MODULE AND ASSEMBLY METHOD THE SAME

(75) Inventor: SHIH-MIN LO, Tu-Cheng (TW)

(73) Assignee: HON HAI PRECISION INDUSTRY CO., LTD., Tu-Cheng (TW)

(21) Appl. No.: 12/980,374

(22) Filed: Dec. 29, 2010

(30) Foreign Application Priority Data
Aug. 19, 2010 (TW) 99127654

(51) Int. Cl. H04N 5/225

(52) U.S. Cl. 348/374; 348/E05.024

(57) ABSTRACT

A camera module includes a first circuit board, a holder, a lens module, an image sensor chip, a filter, and a second circuit board. The holder includes a sleeve and a base connected to an end of the sleeve. The lens module is received in the sleeve. The holder is mounted on the first circuit board. The base defines a receiving portion. The image sensor chip is electrically fixed to the first circuit board and received in the receiving portion. The filter is received in the first receiving portion corresponding to the image sensor chip. The second circuit board is electrically connected to the first circuit board. The second circuit board is received in the first receiving portion and fixed to the first circuit board. Incident light passes through the lens module and the filter in that order, and finally projects on the image sensor chip.

### BACKGROUND

1. Technical Field

The present disclosure relates to an image capture, and more particularly, to a camera module used for an electronic device and an assembly method the same.

2. Description of Related Art

Camera modules are widely used in electronic devices such as personal digital assistants, mobile phones, portable computers, and others.

A typical cameral module includes a circuit board, a holder, a lens module, an image sensor chip, and a filter. The holder includes a sleeve and a base connected to an end of the sleeve. The lens module is received in the sleeve. The holder is mounted on the circuit board. The base is a hollow chamber. The image sensor chip is electrically fixed to the first circuit board and received on the base. The filter is received in the base corresponding to the image sensor chip. Incident light is capable of passing through the lens module and the filter in that order, and finally projecting on the image sensor. The camera module further includes a plurality of electronic elements and integrated circuits disposed on the circuit board.

However, a distribution density of the electronic elements and the integrated circuits on the circuit board is very high such that the circuit board must be large, and as a result, the volume of the camera module is also large.

Therefore, there is room for improvement within the art.

### BRIEF DESCRIPTION OF THE DRAWINGS

The components in the drawings are not necessarily drawn to scale, the emphasis instead being positioned upon clearly illustrating the principles of the present disclosure. Moreover, in the drawings, like reference numerals designate corresponding parts throughout the views.

FIG. 1 is cross section of a first embodiment of a camera module.

FIG. 2 is cross section of a second embodiment of a camera module.

FIG. 3 is a flowchart of an assembly method for a camera module, such as, for example, that of FIG. 1.

### DETAILED DESCRIPTION

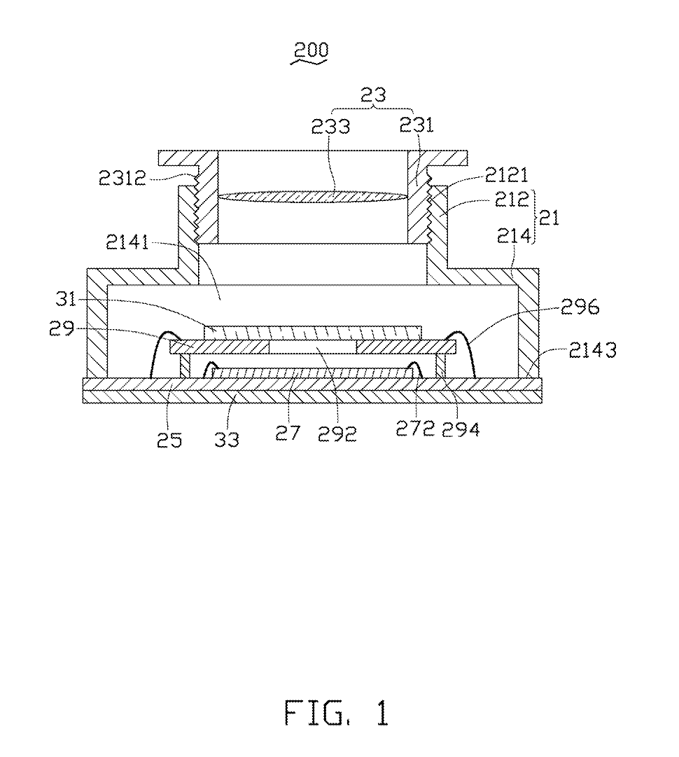

Referring to FIG. 1, a first embodiment of a camera module 200 includes a holder 21, a lens module 23, a first circuit board 25, an image sensor chip 27, a second circuit board 29, and a filter 31. The lens module 23 is partially received in the holder 21. The holder 21 is mounted on the first circuit board 25. The image sensor chip 27, the second circuit board 29, and the filter 31 are received in the holder 21.

The holder 21 includes a sleeve 212 and a base 214 connected to an end of the sleeve 212. The sleeve 212 is hollow and substantially cylindrical, and forms an internal thread 2121 on an inner surface of the sleeve 212. The base 214 is substantially rectangular and defines a receiving portion 2141. The receiving portion 2141 is a substantially rectangular groove depressed from an end of the base 214 away from the sleeve 212. The receiving portion 2141 communicates with the sleeve 212. The base 214 includes a fixing end 2143 at an end of the base 214 away from the sleeve 212.

The lens module 23 includes a lens barrel 231 and at least one lens 233 received in the lens barrel 231. The lens barrel 231 forms an external thread 2312 on an outer surface of the lens barrel 231. The lens module 23 is threaded into the sleeve 212 of the holder 21.

The holder 21 is mounted on the first circuit board 25 by fixing the fixing end 2143 to the first circuit board 25. The first circuit board 25 may be a rigid printed circuit board, a flexible printed circuit board, or a rigid flex printed circuit board. The image sensor chip 27 is received in the receiving portion 2141, and electrically fixed to a middle portion of the first circuit board 25 by wires 272 corresponding to the lens 233. The image sensor chip 27 may be a charge coupled device (CCD), or complementary metal oxide semiconductor (CMOS).

The second circuit board 29 is smaller than the first circuit board 25. The second circuit board 29 defines a light port 292 in a middle portion thereof. The camera module 200 further includes a plurality of adhesive blocks 294. The second circuit board 29 is received in the receiving portion 2141 and fixed to the first circuit board 25 by the adhesive blocks 294 with the light port 292 corresponding to the lens 233. The image sensor chip 27 is positioned between the first circuit board 25 and the second circuit board 29. It should be pointed out that the second circuit board 29 may be fixed to the image sensor chip 27 alternatively. The second circuit board 29 is electrically connected to the first circuit board 25 by wires 296. The second circuit board 29 may also be a rigid printed circuit board, a flexible printed circuit board, or a rigid flex printed circuit board.

The filter 31 is fixed to a side of the second circuit board 29 away from the image sensor chip 25 and shields the light port 292. Incident light passes through the lens 233 of the lens module 23 and the filter 31 in order, and is incident on the image sensor chip 27. The camera module 200 further includes a plurality of electronic elements and integrated circuits (not shown) selectively disposed on the first circuit board 27 or the second circuit board 29. It should be pointed out that the filter 31 may be fixed to the base 214 directly, as long as the filer 31 corresponds to the image sensor chip 27 and the lens 233.

The camera module 200 further includes a substrate 33 attached to a side surface of the first circuit board 25 away from the holder 21 to support the first circuit board 25.

The electronic elements and integrated circuits of the camera module 200 may be selectively disposed on the first circuit board 27 or on the second circuit board 29. As a result the camera module 200 has a compact configuration with a relatively low distribution density of electronic elements and integrated circuits, and the camera module 200 may be easily manufactured.

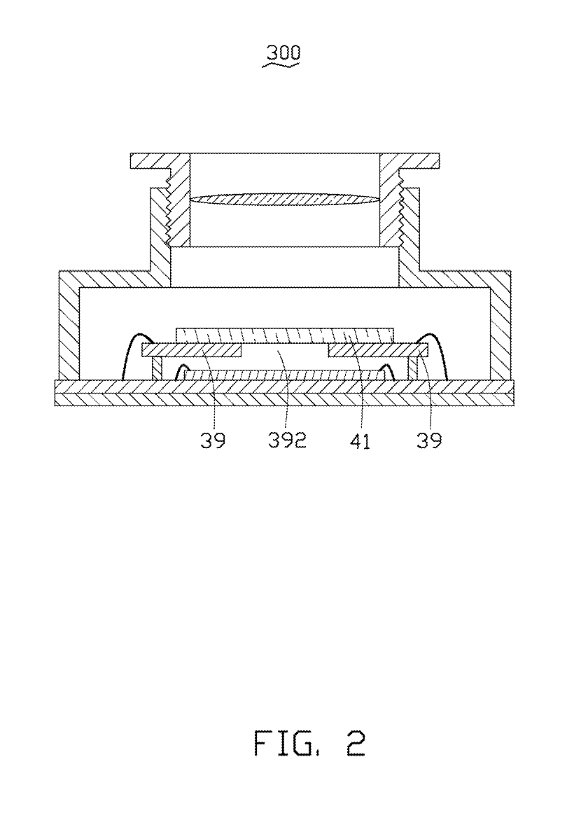

Referring to FIG. 2, a second embodiment of a camera module 300 differs from the first embodiment of the camera module 200 only in that the camera module 300 includes two second circuit boards 39. The two second circuit boards 39 are spaced apart to cooperatively define a gap 392 corresponding to the image sensor chip 41. The filter 41 interconnects the two second circuit boards 39.

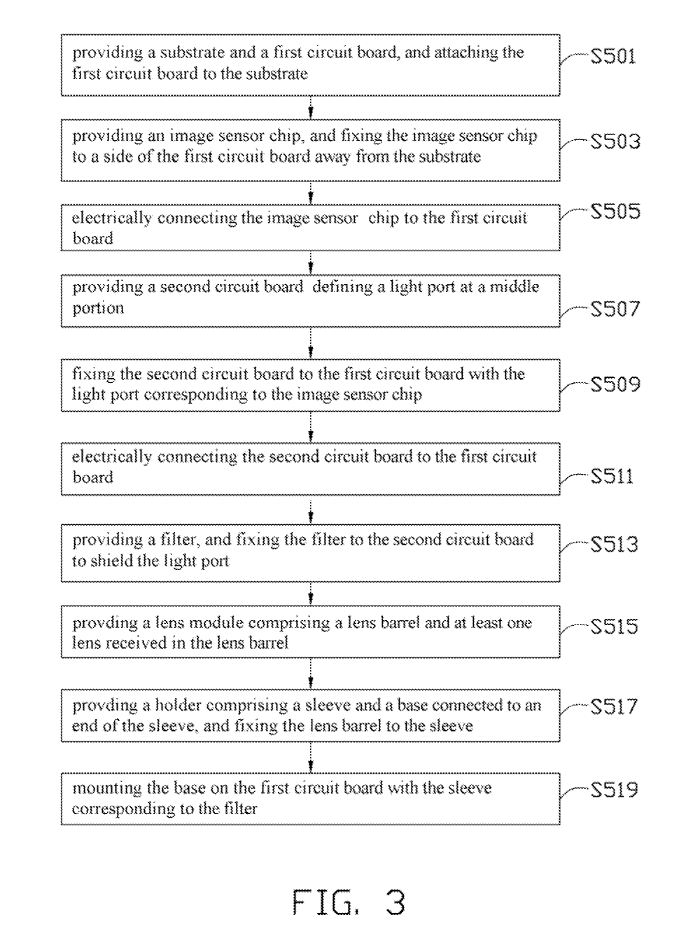

FIG. 3 shows an assembly method of a camera module such as, for example, that of the first embodiment. The steps are not limited in the illustrated order and some steps may be performed simultaneously or partially simultaneously.

In step S501, a substrate 33 and a first circuit board 25 are provided, and the first circuit board 25 is attached to a side surface of the substrate 33. A part of the electronic elements and integrated circuits of the camera module 200 are disposed on the first circuit board 25.

In step S503, an image sensor chip 27 is provided, and fixed to a side surface of the first circuit board 25 opposite to the substrate 33.

In step S505, the image sensor chip 27 is electrically connected to the first circuit board 25. In the illustrated embodiment, the image sensor chip 27 is connected to the first circuit board 25 by wires 272.

In step S507, a second circuit board 29 is provided, the second circuit board 29 defines a light port 292 at a middle portion thereof. Other parts of the electronic elements and integrated circuit of the camera module 200 are disposed on the second circuit board 29.

In step S509, the second circuit board 29 is fixed to a side of the first circuit board 25 with the image sensor chip 27 positioned between the first circuit board 25 and the second circuit board 29. The light port 292 corresponds to the image sensor chip 27. In the illustrated embodiment, the second circuit board 29 is fixed to the first circuit board 25 by the adhesive blocks 294 to space the first circuit board 25 and the second circuit board 29 apart.

In step S511, the second circuit board 29 is electrically connected to the first circuit board 25 by wires 296.

In step S513, a filter 31 is provided, and fixed to a side of the second circuit board 29 away from the first circuit board 25. The filter 31 shields the light port 292.

In step S515, a lens module 23 is provided. The lens module 23 includes a lens barrel 231 and at least one lens 233 received in the lens barrel 231. The lens barrel 231 forms an external thread 2312 on the outer surface of the lens barrel 231.

In step S517, a holder 21 is provided. The holder 21 includes a sleeve 212 and a base 214 connected to an end of the sleeve 212. The sleeve 212 is substantially hollow and cylindrical, and forms an internal thread 2121 thereon. The lens module 23 is threaded into the sleeve 212 of the holder 21. The base 214 defines a receiving portion 2141 communicating with the sleeve 212.

In step S519, the base 214 is mounted on the first circuit board 29 with the sleeve 212 corresponding to the filter 31. The image sensor chip 27, the second circuit board 29, and the filter 31 are received in the receiving portion 2141.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A camera module, comprising:
a first circuit board;
a holder mounted on the first circuit board, the holder comprising a sleeve and a base connected to an end of the sleeve, the base defining a receiving portion;
a lens module received in the sleeve;
an image sensor chip electrically fixed to the first circuit board and received in the receiving portion;
a filter received in the receiving portion corresponding to the image sensor chip, such that incident light passes through the lens module and the filter in that order, and finally projecting on the image sensor chip; and
a second circuit board electrically connected to the first circuit board, received in the receiving portion, and fixed to the first circuit board.

2. The camera module of claim 1, wherein the first circuit board and the second circuit board are at opposite sides of the image sensor chip, and the second circuit board defines a light port corresponding to the image sensor chip.

3. The camera module of claim 2, wherein the second circuit board is electrically connected to the first circuit board by wires.

4. The camera module of claim 2, wherein the filter is fixed to the second circuit board and shields the light port.

5. The camera module of claim 4, wherein the filter is fixed to the base and corresponds to the light port.

6. The camera module of claim 1, further comprising another second circuit board, wherein the two second circuit boards are spaced apart, the image sensor chip is positioned between the first circuit board and the second circuit board, and the two second circuit boards cooperatively defines a gap corresponding to the image sensor chip.

7. The camera module of claim 6, wherein the filter interconnects the two second circuit boards.

8. The camera module of claim 1, wherein the second circuit board is fixed to the first circuit board by at least one adhesive block with the image sensor chip positioned between the first circuit board and the second circuit board.

9. An assembly method for a camera module, comprising:
providing a substrate and a first circuit board attached to the substrate;
providing an image sensor chip, and fixing the image sensor chip to a side of the first circuit board away from the substrate;
electrically connecting the image sensor chip to the first circuit board;
providing a second circuit board defining a light port at a middle portion;
fixing the second circuit board to the first circuit board with the light port corresponding to the image sensor chip;
electrically connecting the second circuit board to the first circuit board;
providing a filter, and fixing the filter to the second circuit board to shield the light port;
providing a lens module comprising a lens barrel and at least one lens received in the lens barrel;
providing a holder comprising a sleeve and a base connected to an end of the sleeve, and fixing the lens barrel to the sleeve; and
mounting the base on the first circuit board with the sleeve corresponding to the filter.

10. The method of claim 9, wherein the second circuit board is electrically connected to the first circuit board by wires.

11. The method of claim 9, wherein the second circuit board is fixed to the first circuit board by at least one adhesive block.
